(19) United States
(12) Patent Application Publication
(10) Pub. No.: US 2026/0003132 A1
(43) Pub. Date: Jan. 1, 2026

(54) FIBER OPTIC CONNECTORS AND DUST PLUGS WITH SEALING MEMBERS

(71) Applicant: CORNING RESEARCH & DEVELOPMENT CORPORATION, CORNING, NY (US)

(72) Inventors: Marisol Aponte Cervantes, Reynosa (MX); Marco Antonio Moreno Gonzalez, Reynosa (MX)

(21) Appl. No.: 18/756,392

(22) Filed: Jun. 27, 2024

(51) Int. Cl. G02B 6/38

(52) U.S. Cl. CPC G02B 6/3849; G02B 6/387

(57) ABSTRACT

In one embodiment, a fiber optic connector includes a housing having a rear end and a front end with a longitudinal passageway extending from the rear end to the front end, the housing having a front portion, a rear portion, and at least one groove within at least one of the front portion and the rear portion, and at least one sealing member disposed within the at least one groove, wherein the at least one sealing member is fabricated from polytetrafluoroethylene.

### FIELD

The present disclosure is directed to fiber optic connector assemblies and, more particularly, to fiber optic connector assemblies for mating with ports of a multiport terminal.

### BACKGROUND

Optical fiber is increasingly being used for a variety of applications, including but not limited to broadband voice, video, and data transmission. As bandwidth demands increase optical fiber is migrating deeper into communication networks such as in fiber to the premises applications such as FTTx, 5G, and the like. As optical fiber extends deeper into communication networks there exists a need for building more complex and flexible fiber optic networks in a quick and easy manner.

Fiber optic connectors are often inserted into a receiving port, such as a port of a multiport terminal. Preferably there should be a sealing element between the fiber optic connector and an inner wall of the port to prevent liquid, dust, and/or debris from the environment from entering the port and/or the fiber optic connector. The sealing element is operable to compress to provide an environmental seal, and may be an elastomer O-ring, for example. However, repeated insertion and withdrawal of a fiber optic connector from the port can cause damage to the sealing element, such as causing micro-tears that compromise the sealing ability of the sealing element. Thus, liquid, dust and/or debris may enter the port of the multiport terminal and thereby cause optical loss.

Consequently, an additional lubricant is added to the fiber optic connector on or proximate the sealing element to reduce the friction between the sealing element and an interior surface of the port. This reduced friction minimizes the occurrence of damage to the sealing element due to insertion and removal of the optical connector with respect to the port. However, the inclusion of an additional lubricant has several drawbacks. First, it is difficult to apply to the sealing element of the fiber optic connector. In one manual process, a lubricant, such as a grease, is added to a container that holds loose O-rings. The lubricant and O-rings are then manually mixed together in the container. Then, individual O-rings are applied to individual optical connectors. In another manual process, an O-ring is applied to a fiber optic connector, and then lubricating grease is applied with a syringe. Both of these processes are highly dependent on the operator, and can lead to too much or too little grease being applied. Further, automated lubrication application processes require expensive equipment that frequency needs to be maintained.

Second, the additional lubricant can become dislodged and located within the optical path of the fiber optic connector, thereby occluding the optical signal. Thus, the additional lubricant can lead to optical loss. Excess lubricant can also be ejected from the port at the port opening and accumulate at the face of the multiport. This excess lubricant can capture dust and debris, which can then enter the port upon insertion and removal of the fiber optic connector into and out of the port of the multiport.

Third, lubricants can often degrade the elastomer material of traditional sealing elements, which can lead to micro-tears or complete tearing of the sealing element. Lubricants that are compatible with the elastomer material of traditional sealing elements can be costly.

Consequently, there exists an unresolved need for fiber optic connectors and ports having enhanced sealing capabilities.

### SUMMARY

Various embodiments of fiber optic connector assemblies and dust plugs for multiport terminals are disclosed. Embodiments of the present disclosure minimize or eliminate the need for additional lubricant to be applied to the sealing member of a fiber optic connector by using sealing members fabricated from polytetrafluoroethylene (PTFE). The low coefficient of friction provided by the PTFE sealing member allows for repeated insertion and removal of a fiber optic connector into and from a port without additional lubricant. By not providing lubricant, additional manufacturing processing steps are eliminated, and the integrity of the optical connection between the fiber optic connector and the port is maintained by eliminating a source of optical loss, as well as eliminating the degradation of the sealing element due to the additional lubricant. The PFTE sealing members, such as O-rings, can be used in a wide variety of optical connector types and configurations, as well as dust plugs for sealing unused ports of a multiport.

In one embodiment, a fiber optic connector includes a housing having a rear end and a front end with a longitudinal passageway extending from the rear end to the front end, the housing having a front portion, a rear portion, and at least one groove within at least one of the front portion and the rear portion, and at least one sealing member disposed within the at least one groove, wherein the at least one sealing member is fabricated from polytetrafluoroethylene.

In another embodiment, a fiber optic connector includes a crimp assembly, a connector assembly, a shroud, and at least one sealing member fabricated from polytetrafluoroethylene. The crimp assembly includes a crimp housing and a crimp band, wherein the crimp housing has two half-shells being held together by the crimp band, the two half-shells having a longitudinal passageway for passing at least one optical fiber therethrough, at least one cable clamping portion, and a connector assembly clamping portion, wherein the at least one cable clamping portion secures at least one tensile element of an optical cable. The connector assembly includes a connector body and a ferrule, wherein a portion of the connector assembly is secured in the connector assembly clamping portion of the two half-shells of the crimp housing. The shroud is coupled to the crimp assembly and includes at least one groove

In another embodiment, a dust plug assembly includes a dust plug body that includes a lanyard receiving feature, a sealing sleeve attached to an end of the dust plug body, where the sealing sleeve has a passageway therethrough. The lanyard receiving feature is disposed within the passageway. The dust plug body and the sealing sleeve define a primary groove. The dust plug assembly further includes a lanyard that includes an attachment feature, where the attachment feature is coupled to the lanyard receiving feature, and the lanyard and the sealing sleeve define a secondary groove. The dust plug assembly also includes a sealing sleeve attached to an end of the dust plug body. A primary sealing member disposed in the primary groove and a secondary sealing member disposed in the secondary groove. The primary sealing member and the secondary sealing member are fabricated from polytetrafluoroethylene.

Additional features and advantages will be set forth in the detailed description which follows, and in part will be readily apparent to those skilled in the art from that description or recognized by practicing the same as described herein, including the detailed description that follows, the claims, as well as the appended drawings.

It is to be understood that both the foregoing general description and the following detailed description present embodiments that are intended to provide an overview or framework for understanding the nature and character of the claims. The accompanying drawings are included to provide a further understanding of the disclosure and are incorporated into and constitute a part of this specification. The drawings illustrate various embodiments and together with the description serve to explain the principles and operation.

### BRIEF DESCRIPTION OF THE FIGURES

FIG. 1 is an isometric view of an example fiber optic connector according to one or more embodiments described and illustrated herein.

FIG. 2 is close-up isometric view of the example fiber optic connector of FIG. 1 according to one or more embodiments described and illustrated herein.

FIG. 3 is a cross-sectional view of the example fiber optic connector of FIG. 1 according to one or more embodiments described and illustrated herein.

FIG. 4 is a close-up cross-sectional side view of the example fiber optic connector of FIG. 1 according to one or more embodiments described and illustrated herein.

FIG. 5 is a close-up isometric view of a nominal housing portion of the example fiber optic connector of FIG. 1 according to one or more embodiments described and illustrated herein.

FIG. 6 is an isometric cutaway view of the example fiber optic connector of FIG. 1 according to one or more embodiments described and illustrated herein.

FIG. 7 is an isometric view of an example multiport assembly according to one or more embodiments described and illustrated herein.

FIG. 8 is a cutaway isometric view of a fiber optic connector inserted into a port of the multiport assembly of FIG. 7 according to one or more embodiments described and illustrated herein.

FIG. 9 is an isometric view of another example fiber optic connector according to one or more embodiments described and illustrated herein.

FIG. 10 is a close-up isometric view of the example fiber optic connector of FIG. 9 according to one or more embodiments described and illustrated herein.

FIG. 11 is isometric view of another multiport assembly according to one or more embodiments described and illustrated herein.

FIG. 12 is an isometric view of an example dust plug according to one or more embodiments described and illustrated herein.

FIG. 13 is an isometric view of another example fiber optic connector according to one or more embodiments described and illustrated herein.

FIG. 14 is an exploded view of the example fiber optic connector of FIG. 13 according to one or more embodiments described and illustrated herein.

FIG. 15 is an isometric view of a shroud of the example fiber optic connector of FIG. 13 according to one or more embodiments described and illustrated herein.

### DETAILED DESCRIPTION

References will now be made in detail to the embodiments of the disclosure, examples of which are illustrated in the accompanying drawings. Whenever possible, like reference numbers will be used to refer to like components or parts.

The concepts disclosed are related to fiber optic connector assemblies and dust plugs for multiport terminals. Embodiments of the present disclosure minimize or eliminate the need for additional lubricant to be applied to the sealing member of a fiber optic connector by using sealing members fabricated from polytetrafluoroethylene (PTFE). The low coefficient of friction provided by the PTFE sealing member allows for repeated insertion and removal of a fiber optic connector into and from a port without additional lubricant. By not providing lubricant, additional manufacturing processing steps are eliminated, and the integrity of the optical connection between the fiber optic connector and the port is maintained by eliminating a source of optical loss, as well as the degradation of the sealing element due to the additional lubricant. The PFTE sealing members, such as O-rings, can be used in a wide variety of optical connector types and configurations, as well as dust plugs for sealing unused ports of a multiport.

More particularly, the PTFE sealing members of the present disclosure are highly resistant to a wide range of chemicals, including, but not limited to, acids, bases, solvents, and fuels, whereas elastomer sealing members may degrade or swell when exposed to certain chemicals. The PTFE sealing members can withstand extreme temperatures, ranging from very low to very high temperatures, without losing their sealing properties. On the other hand, traditional elastomer O-rings have limited temperature resistance and may harden or soften at extreme temperatures.

The low friction and non-stick properties of the PTFE sealing members of the present disclosure minimize or eliminate the need for additional lubricants. The low coefficient of friction of the PTFE sealing members results in smoother operation and reduced wear compared to elastomer O-rings, thereby reducing the risk of sealing member damage. Excellent non-stick properties, which prevent the accumulation of contaminants and reduce the risk of sticking or adhesion, ensuring a longer service life compared to elastomer O-rings. Additionally, the PTFE sealing members of the present disclsoure rings exhibit minimal creep and compression set over time, maintaining their shape and sealing effectiveness, whereas elastomer O-rings may experience deformation or relaxation under pressure, leading to leakage.

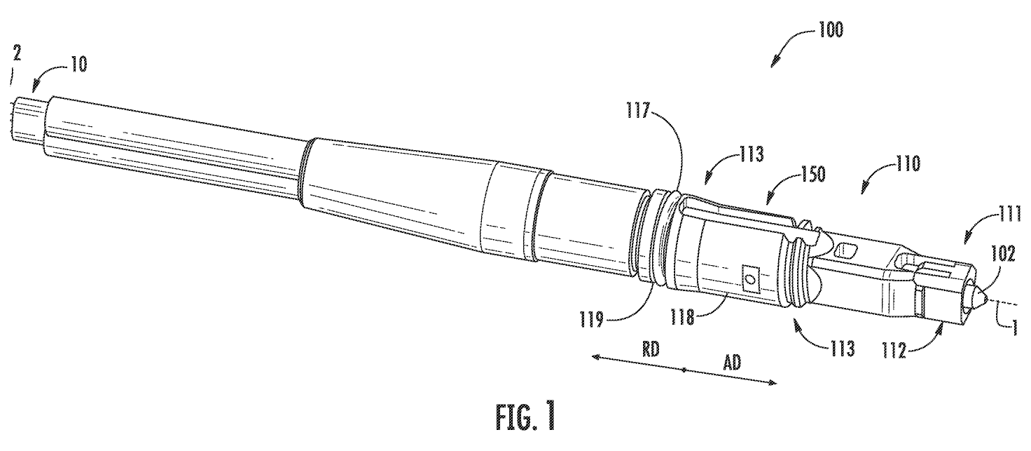

Referring initially to FIG. 1, a isometric view of a fiber optic connector 100 is schematically depicted. The fiber optic connector 100 generally includes a connector housing 110, including a ferrule retaining portion 112 at a front portion 111 of the connector housing 110. The connector housing 110 further includes a rear portion 113 positioned opposite the front portion 111 in an axial direction. The ferrule retaining portion 112 of the connector housing 110 is generally configured to hold and retain a ferrule 102 that is positioned at least partially within the ferrule retaining portion 112.

In embodiments, the fiber optic connector 100 is coupled to a fiber optic cable 10 at the rear portion 113 of the fiber optic connector 100. The fiber optic cable 10 generally includes an optical fiber 12 extending through the fiber optic cable 10. The optical fiber 12 may generally extend through the connector housing 110 and the ferrule 102 along a longitudinal axis 114 of the connector housing 110. For fiber optic cables 10 including a single optical fiber 12, the optical fiber 12 may be coaxial with the longitudinal axis 114. For multifiber cables, this alignment will be orthogonally offset for one, more than one, or all of the optical fibers of the cable.

In embodiments, the connector housing 110 generally includes an outer surface 118 that extends around a perimeter of the connector housing 110, and the outer surface 118 may include one or more cross-sectional shapes. For example, in the embodiment depicted in FIG. 1, the front portion 111 of the connector housing 110 includes a rectangular cross-section including planar sides, while the rear portion 113 of the connector housing 110 includes a curved outer surface 118.

The rear portion 113 comprises a groove 119, such as an annular groove, that receives a sealing member 117. Thus, the sealing member 117 is seated within the groove 119 at the rear portion of the connector housing 110. The sealing member 117 is fabricated from PTFE, thereby providing it with a low coefficient of friction such that additional lubricant, such as grease, is not needed to be applied. As shown in FIG. 1, the sealing member 117 may be an O-ring.

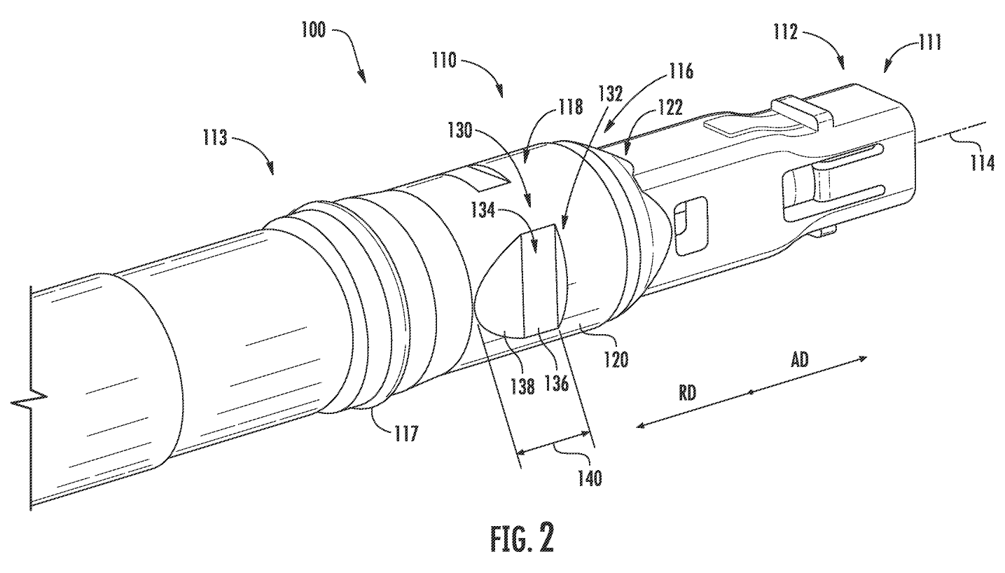

Referring to FIG. 2, a lower isometric view of the connector housing 110 is schematically depicted. The connector housing 110 includes a nominal housing portion 120 defined on the outer surface 118 of the connector housing 110. The nominal housing portion 120 extends about and axially along the outer surface 118 of the connector housing 110 but may be interrupted by a variety of distinctive surface features defined on the outer surface 118 of the connector housing 110. The nominal housing portion 120 is referenced herein as being “nominal” to help distinguish it from the various distinctive surface features that are defined on the connector housing 110. Without these distinctive surface features, the nominal housing portion 120 would form a relatively uniform and continuous surface of the connector housing 110, and would extend far enough along a length of the connector housing 110 to provide a convenient surface for a user to handle the connector housing 110 without the use of a specialized connector handling tool or other supplemental hardware. Reference herein to a surface feature, e.g., a keying portion or a locking portion, that is “defined on” the outer surface 118 of the connector housing 110 contemplates that the surface feature may be a subtractive surface feature, like a cut-out, or an additive surface feature, like a projection.

In the embodiment depicted in FIG. 2, the connector housing 110 includes a locking portion 130 defined on the outer surface 118 at the rear portion 113 of the connector housing 110. The locking portion 130 is positioned on a curved surface of the outer surface 118 in the embodiment depicted in FIG. 2, and generally includes a port engagement face 132 that extends inward from the nominal housing portion 120 toward the longitudinal axis 114 of the connector housing 110. In one embodiment, the port engagement face 132 may generally define an edge-to-edge cross sectional cut-out of the connector housing 110, in which the port engagement face 132 extends across the outer surface 118 in a direction transverse to the longitudinal axis 114. In other embodiments, the port engagement face 132 may generally define a pocket cut-out of the connector housing 110, in which the port engagement face 132 extends radially inward from the outer surface 118 toward the longitudinal axis 114, and is bounded in a circumferential direction by the nominal housing portion 120.

The locking portion 130 further includes a locking portion recess 134 positioned rearward of the port engagement face 132 and inward of the nominal housing portion 120. The locking portion recess 134 includes a generally planar surface 136 that is oriented transverse to the port engagement face 132 and that extends at least partially across the outer surface 118 of the connector housing 110. The locking portion recess 134 may also include a ramp portion 138 positioned rearward of the planar surface 136 and that extends outward from the planar surface 136 to the nominal housing portion 120 moving along the locking portion recess 134 in the retracting direction.

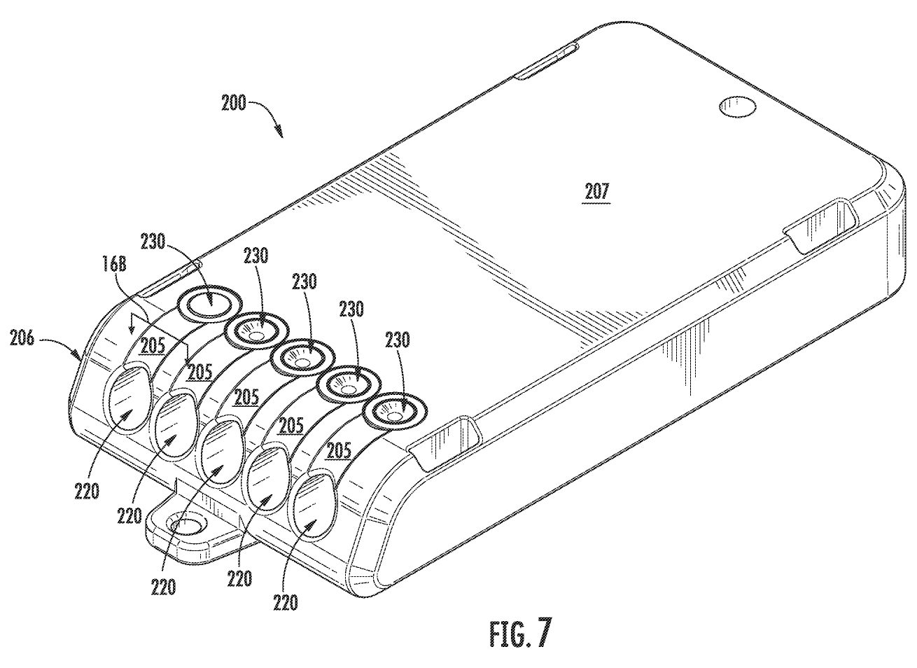

In embodiments, the port engagement face 132 extends inward from the nominal housing portion 120 of the connector housing 110 by a distance that corresponds to features of a push-button securing member 230 (FIG. 7) such that the connector housing 110 may be selectively coupled to and removed from the push-button securing member 230 (FIG. 7). In one embodiment, the port engagement face 132 extends inward from the nominal housing portion 120 by a distance of at least about 0.75 millimeters.

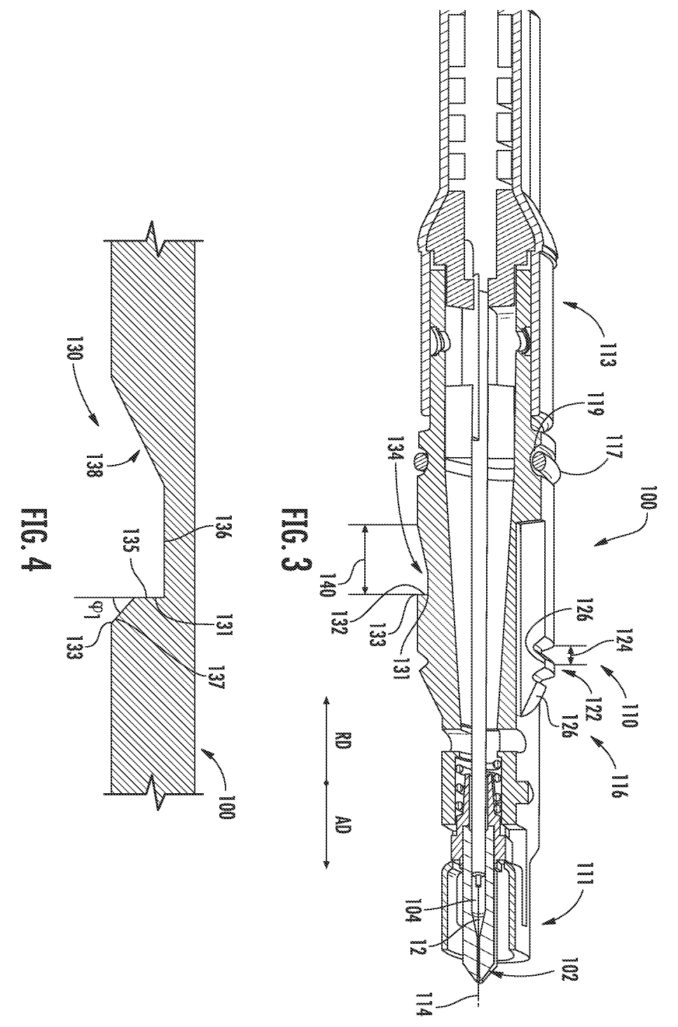

Referring collectively to FIGS. 2 and 3, the port engagement face 132 generally defines a planar surface that is oriented transverse to the longitudinal axis 114. The port engagement face 132 includes and extends between an inner end 131 and an outer end 133 that is positioned outward of the inner end 131. The outer end 133 may include a rounded or chamfered edge, which may assist in preventing breakage of the outer end 133 when the connector housing 110 is forcibly removed from a connection port, as described in greater detail herein.

In some embodiments, the outer end 133 is positioned closer to the front portion 111 of the connector housing 110 in an axial direction than the inner end 131, such that the port engagement face 132 is both rearward and outward facing. In these embodiments, the port engagement face 132 generally defines a plane that intersects the longitudinal axis 114 at an angle that is less than 30 degrees evaluated from perpendicular.

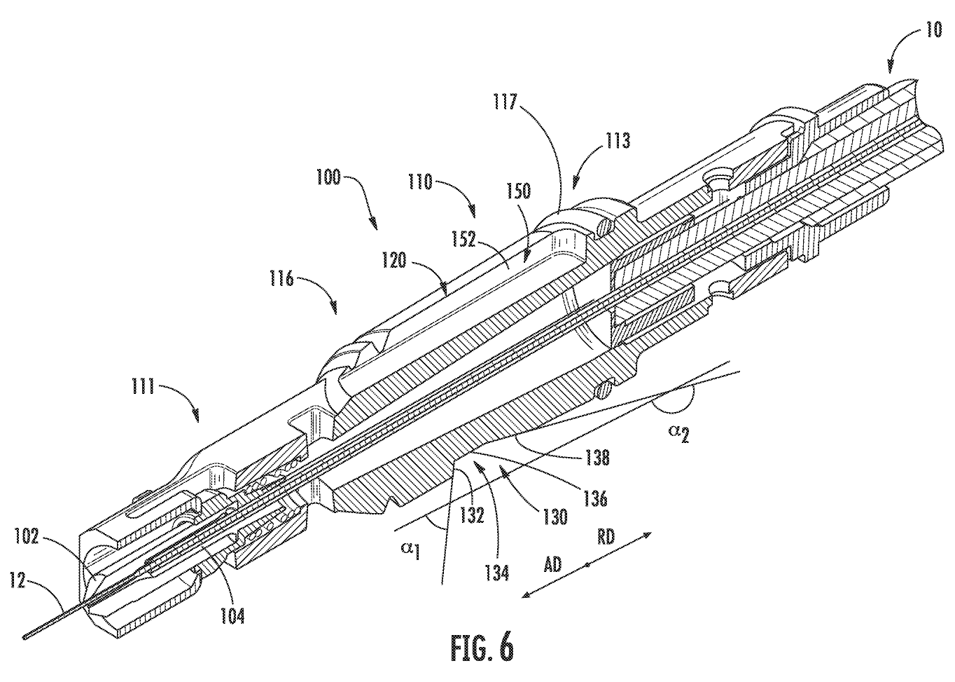

For example, as best shown in FIG. 6, the port engagement face 132 is a formed as a rearward-facing cut-out that lies in a plane that intersects the longitudinal axis 114 at an acute angle α1, and the ramp portion 138 is formed as a forward-facing cut-out that lies in a plane that intersects the longitudinal axis 114 at an angle α2 that is greater than α1. In embodiments, α2 is generally between 110 degrees and 180 degrees and may generally be selected to correspond to a feature of a push-button securing member 230 (FIG. 7), as described in greater detail herein. As noted above, in embodiments, the angle α1 is generally within 30 degrees of perpendicular (i.e., the port engagement face 132 lies in a plane that intersects the longitudinal axis at an angle between 60 degrees and 90 degrees) such that the port engagement face 132 is outward and rearward facing. By orienting the port engagement face 132 in a rearward and outward facing orientation, the port engagement face 132 may be selectively disengaged from a push-button securing member 230 (FIG. 7) upon the application of a force above a predetermined threshold, as described in greater detail herein. In other embodiments, the port engagement face 132 is oriented such that the port engagement face 132 that extends in a plane that is orthogonal to the longitudinal axis 114.

Referring to FIG. 4, in some embodiments, the port engagement face 132 may include a locking face 135 that extends in a plane that is orthogonal to the longitudinal axis 114 (FIG. 3), and a release face 137 positioned outward from the locking face 135. In the embodiment depicted in FIG. 4, the release face 137 extends in a plane that intersects the locking face 135 at an angle φ1. In embodiments, the angle φ1 is between about 0 degrees and 30 degrees, inclusive of the endpoints, such that the release face 137 is outward and rearward facing. By including both a locking face 135 that extends in a plane that is orthogonal to the longitudinal axis 114 and a release face 137 that is outward and rearward facing, the port engagement face 132 of the connector housing 110 may be rigidly connected to a push-button securing member 230 (FIG. 7) engaged with the locking face 135. However, the port engagement face 132 of the connector housing may be releasably engaged with a push-button securing member 230 (FIG. 7) engaged with the release face 137 upon the application of a force above a predetermined threshold, as described in greater detail herein.

Referring again to FIGS. 2 and 3, in embodiments, the front portion 111 has a perimeter extending around the outer surface 118 of the front portion 111 that is less than a perimeter extending around the outer surface 118 of the rear portion 113 of the connector housing 110. The connector housing further includes a transition region 116 positioned between the front portion 111 and the rear portion 113, where the perimeter of the connector housing 110 extending around the outer surface 118 increases moving along the transition region 116 from the front portion 111 to the rear portion 113 in an axial direction.

In embodiments, the connector housing 110 includes a thread 122 extending around the outer surface 118 at the transition region 116. The thread 122 generally includes crests 126 that are separated from one another by a pitch 124. The thread 122 may be utilized to selectively couple one or more conversion housings to the connector housing 110, as described in greater detail herein. While the thread 122 is depicted as being positioned on the transition region 116, it should be understood that the thread 122 may be alternatively or additionally positioned on the outer surface 118 of the front portion 111 and/or the rear portion 113 of the connector housing 110.

In embodiments, the pitch 124 between the crests 126 of the thread 122 is less than a length 140 of the locking portion recess 134 evaluated in an axial direction. Because the pitch 124 of the thread 122 is less than the length 140 of the locking portion recess 134, the locking portion recess 134 may selectively interact with a push-button securing member 230 (FIG. 7) while the pitch 124 prevents the thread 122 from interacting the push-button securing member 230 (FIG. 7), as described in greater detail herein.

Referring particularly to FIG. 3, the ferrule 102 is positioned within and engaged with the ferrule retaining portion 112 of the connector housing 110. The ferrule 102 defines an optical fiber bore 104 that is configured to retain the optical fiber 12. The optical fiber bore 104 is generally aligned with the longitudinal axis 114 of the connector housing 110 such that the longitudinal axis 114 is coaxial with the optical fiber bore 104.

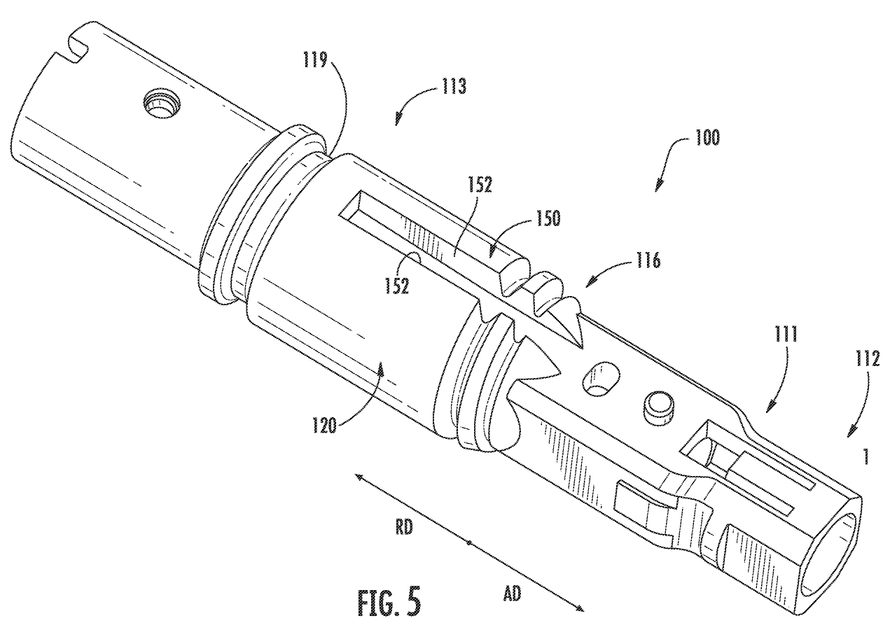

Referring collectively to FIGS. 4 and 5, a isometric view of the connector housing 110 and a cross-section of the fiber optic connector 100 are schematically depicted. The connector housing 110 includes a keying portion 150 defined on the outer surface 118 of the connector housing 110, the keying portion 150 including pair of opposing contact surfaces 152. The opposing contact surfaces 152 are structurally configured to inhibit rotation of the connector housing 110 about the longitudinal axis 114 when engaged with a complementary keying portion of an optical connection port 220 (FIG. 7). In the embodiment depicted in FIGS. 4 and 5, the keying portion 150 is positioned at the rear portion 113 of the connector housing 110, and interrupts the nominal housing portion 120. In embodiments, the keying portion 150 of the connector housing 110 extends closer to the front portion 111 of the connector housing 110 than does the locking portion 130 of the connector housing 110, such that the keying portion 150 may contact features of an optical connection port 220 (FIG. 7) prior to the locking portion 130, as described in greater detail herein. In the embodiment depicted in FIG. 5, the keying portion 150 of the connector housing 110 extends at least partially into the transition region 116 of the connector housing 110. In some embodiments, the keying portion 150 may only extend forward into the transition region 116, such that the keying portion 150 terminates prior to the front portion 111 of the connector housing 110 moving forward along the outer surface 118. The keying portion 150 may generally extend in an axial direction a distance that is longer than the transition region 116 and/or the front portion 111 in the axial direction.

Referring now to FIG. 7, a isometric view of a multiport assembly 200 is schematically depicted, respectively. The multiport assembly 200 generally includes a plurality of optical connection ports 220 that are configured to receive fiber optic connectors 100 (FIG. 1). The fiber optic connectors 100 may be single-fiber or multi-fiber. In the embodiment depicted in FIG. 7, the multiport assembly 200 includes five optical connection ports 220; however, it should be understood that multiport assemblies 200 according to the present disclosure may include any suitable number of optical connection ports 220. The multiport assembly 200 includes an upward-facing top surface 207 and an outward-facing front end 206. In embodiments, the multiport assembly 200 generally includes scallops 205 associated and aligned with each of the optical connection ports 220 and extending between the outward-facing front end 206 and the top surface 207. The scallops 205 generally include a cut-out extending into the outward-facing front end 206 and the top surface 207 of the multiport assembly 200 and may provide a tactile indication of the positioning of the optical connection ports 220 and a push-button securing member 230 associated with the optical connection port 220. For example, a user may insert a fiber optic connector 100 (FIG. 1) into the optical connection port 220, and/or may depress a push-button securing member 230 to remove a fiber optic connector 100 (FIG. 1) from the multiport assembly 200. In some settings, the multiport assembly 200 may be difficult to reach and/or the user may not have a direct line of sight to the optical connection port 220 and/or the push-button securing member 230, and the scallop 205 may provide tactile feedback to the user to locate the optical connection port 220 and/or the push-button securing member 230.

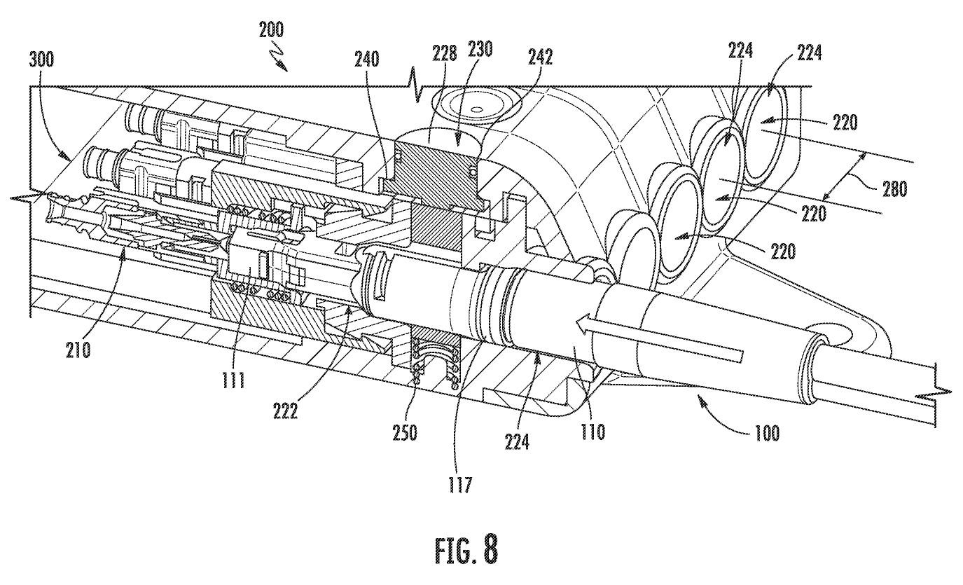

Referring now to FIG. 8, when the fiber optic connector 100 is fully inserted to the connection port passageway 222, the front portion 111 of the connector housing 110 may be engaged with an individual optical adapter 210 of a plurality of optical adapters 210 positioned in the cavity 204 that correspond to each of the optical connection ports 220. Each of the optical adapters 210 are structurally configured to receive, align, and optically couple dissimilar optical connectors. For example, the optical adapters 210 are configured to receive the fiber optic connector 100 on one side, and optically couple the fiber optic connector 100 to another fiber optic connector including a different shape.

Additionally, the push-button securing member 230 may be re-positioned back into the engaged position. More particularly, the port engagement face 132 of the connector housing 110 may be engaged with a connector engagement face 234 of the push-button securing member 230, and a ramp of the push-button securing member 230 may be positioned within the locking portion recess 134 of the connector housing 110. Engagement between the push-button securing member 230 with the port engagement face 132 of the connector housing 110 inhibits axial movement of the connector housing along the retracting direction of the fiber optic connector 100 with respect to the multiport assembly 200, selectively coupling the connector housing 110 to the multiport assembly 200.

The sealing member 117 is compressed between the body of the fiber optic connector 100 and an inner surface of the port passageway 222, thereby forming an environmental seal. The environmental seal prevents liquid, dust and/or debris from entering the interface between the fiber optic connector 100 and the optical adapter 210. The low coefficient of friction of the PFTE of the sealing member 117 allows the fiber optic connector 100 to be easily slid into and out of the port 220 without lubricating grease.

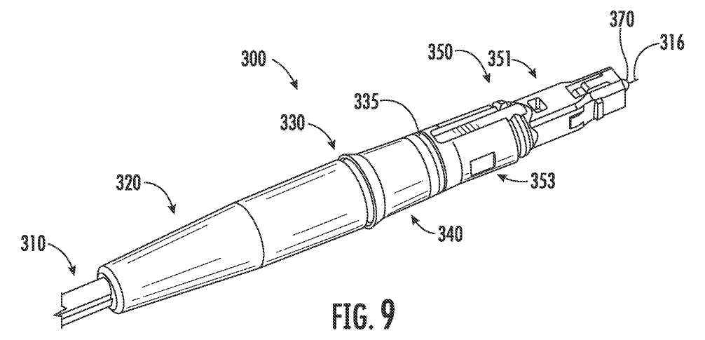

The sealing members of the present disclosure may take on designs other than O-rings. Referring now to FIG. 9, another non-limiting, example fiber optic connector assembly 300 coupled to an optical cable 310 is illustrated. The example fiber optic connector assembly 300 further includes a housing 350, a cable adapter 360, a connector sleeve 340 coupled to a rear end of the housing 350, and a boot 320 coupled to a second end of the connector sleeve 340. As described in more detail below, a secondary sealing member 330 is positioned between the boot 320 and the connector sleeve 340, and a primary sealing member 335 is positioned between the connector sleeve 340 and the housing 350. The primary sealing member 335 and the secondary sealing member 330 are fabricated from PTFE.

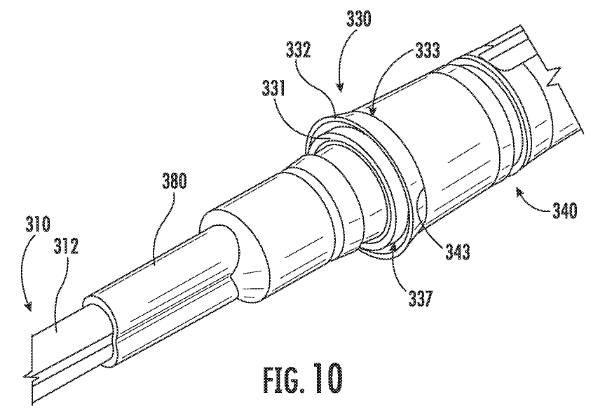

FIG. 10 illustrates a close-up isometric view of the secondary sealing member 330 and the fiber optic connector assembly 300 without the boot 320 installed. Referring to both FIGS. 9 and 10, the example secondary sealing member 330 has a straight portion 331 and a tapered portion 332 extending from an end of the straight portion 331. The tapered portion 332 is configured to be compressed against an inner surface of a port of a terminal. When the fiber optic cable assembly 300 is inserted into a port 220, the tapered portion 332 of the secondary sealing member 330 provides a lead-in surface that compresses against an inner surface of the port 220 (or a dust cap placed on the connector). As shown in FIG. 10, a gap 337 between tapered portion 332 and the straight portion 331 enables further compression of the tapered portion 332 toward the straight portion 331. Thus, the secondary sealing member 330 provides lead-in compressing during insertion of the fiber optic connector assembly into a port or a dust cap, which is not possible with a simple O-ring design.

When the fiber optic connector assembly 300 is fully inserted into a port, the secondary sealing member 330 is located proximate the port opening and thus provides sealing for the full length of the port passageway 222. The primary sealing member 335 is disposed further within the port passageway 222, such as at a location of the sealing member 117 of the fiber optic connector 100 as shown in FIG. 8. The primary sealing member 335 may be configured as an O-ring as depicted by FIGS. 9 and 10, or it may be configured as having a straight portion and a tapered portion in a manner similar to the secondary sealing member 330.

The sealing rings described herein may also be utilized on dust plugs that are operable to close and seal unused ports of a multiport terminal. FIG. 11 illustrates an example fiber optic multiport assembly 200 that includes a multiport terminal 202, a plurality of fiber optic connectors 100, and a plurality of dust plug assemblies 410. The multiport terminal 202 is configured to enable fiber-to-the-infrastructure (FTTx) for optical communication networks. As a non-limiting example, the multiport terminal 202 may be an Evolv™ terminal manufactured and sold by Corning Optical Communications of Charlotte, NC.

Like the multiport terminal shown in FIG. 7, the multiport terminal 202 of FIG. 11 has a front end 206 that includes a plurality of ports 220 operable to receive the plurality of fiber optic connectors 100, such as fiber optic connector of drop cables, for example. The plurality of fiber optic connectors 100 may be PushLok™ connectors, as a non-limiting example.

In some instances, not all of the ports 220 of the multiport terminal 202 may be in use. For example, there may be more ports 220 than subscribers. To protect the internal components of the multiport terminal 202, dust plug assemblies 410 are inserted in unused ports 220. These dust plug assemblies 410 seal the unused ports 220 and protect the enclosure of the multiport terminal 202 from the environment.

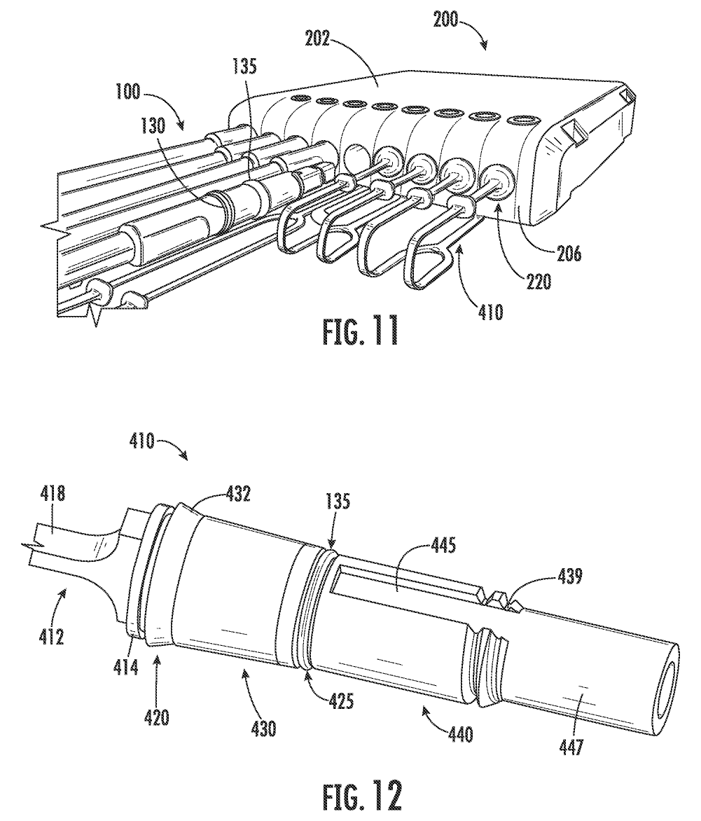

Referring now to FIG. 12, an example dust plug assembly 410 according to one or more embodiments of the present disclosure is illustrated. The example dust plug assembly 410 generally includes a dust plug body 440, a sealing sleeve 430, and a lanyard 412. The dust plug assembly 410 further includes a primary sealing member 425 for providing a primary seal in the interior of a port 220 and a secondary sealing member 420 for providing a secondary seal at the opening of the port 220.

In embodiments, the primary sealing member 425 and/or the secondary sealing member 420 are fabricated from PTFE, which eliminates or substantially reduces the need for additional lubricant, such as lubricating grease. The dust plug body 440 and the sealing sleeve 430 may be molded from a rigid thermoplastic material (e.g., Ultem 2200), for example. The lanyard 412 may be molded from a flexible thermoplastic elastomer (e.g., Hytrel 4556), for example.

The lanyard 412 includes a pull portion 418 and a flange 414. It is noted that the pull portion 418 is illustrated as a stub without a pull tab for ease of illustration. Example pull tabs 416 are shown in FIG. 11. The flange 414 and the sealing sleeve 430 define a secondary groove 432 in which the secondary sealing member 420 is disposed. The example secondary sealing member 420 has a straight portion and a tapered portion extending from an end of the straight portion in a manner that is the same as the sealing member 330 shown in FIG. 10. The tapered portion is configured to be compressed against an inner surface of the port 220 of the multiport terminal 202, as described above with respect to FIGS. 9 and 10.

The primary sealing member 425 is disposed within a primary groove 435 defined by the sealing sleeve 430 and the dust plug body 440. In the illustrated example, the primary sealing member 425 is configured as an O-ring. However, in other embodiments, the primary sealing member 425 may include the tapered portion and the straight portion of the secondary sealing member 420. In still other embodiments, both the primary sealing member 425 and the secondary sealing member 420 may be configured as O-rings.

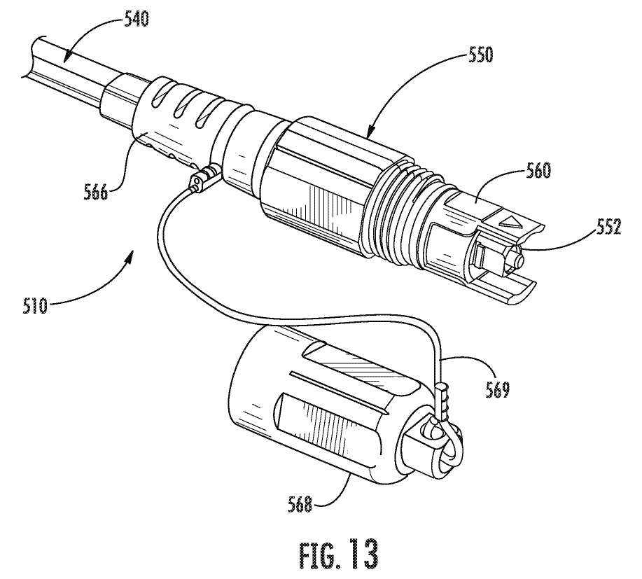

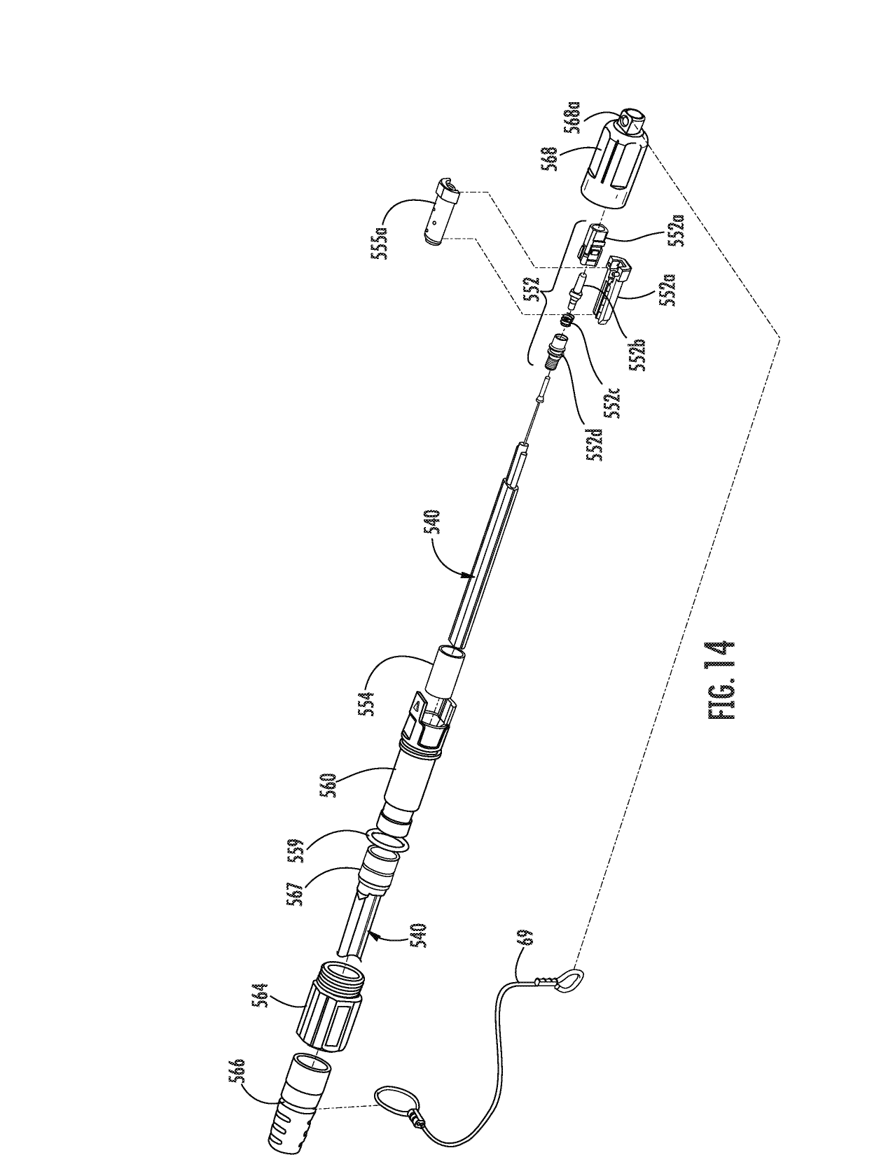

Embodiments are not limited by the type and configuration of optical connector the sealing members are coupled to. FIG. 13 illustrates an example preconnectorized cable 510 including an optical plug connector 550 configured as an OptiTap™ optical connector sold by Corning Optical Communications. In this example, the cable 540 is a flat dielectric cable and optical plug connector 550 uses a connector assembly 552 of the SC type, but other types of connector assemblies such as LC, FC, ST, MT, and MT-RJ are contemplated by using a suitable crimp housing.

FIG. 14 depicts an exploded view of the preconnectorized cable 510 showing cable 540 and optical plug connector 550. In this embodiment, the optical plug connector 50 includes an industry standard SC type connector assembly 552 having a connector body 552a, a ferrule 552b in a ferrule holder (not numbered), a spring 552c, and a spring push 552d. The plug optical connector 550 also includes a crimp assembly (not numbered) that includes a crimp housing having at least one half-shell 555a and a crimp band 554, a shroud 560 having a sealing member 559, a coupling nut 564, a cable boot 566, a heat shrink tube 567, and a protective cap 568 secured to boot 66 by a wire assembly 69.

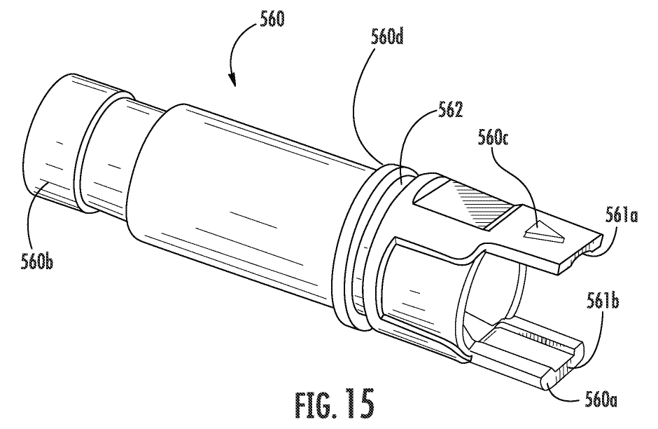

Referring to FIG. 15, a medial portion of the shroud 560 has a groove 562 for seating a sealing member 559. The sealing member 559 provides a weatherproof seal between the plug optical connector 550 and a receptacle (not shown) or a protective cap 568. The sealing member 559 is fabricated from PTFE, which provides a low coefficient of friction that eliminates or reduces the need for additional lubricants, such as lubricating grease. The sealing member 559 may be configured as an O-ring as shown in FIG. 14, or having a straight portion and a tapered portion as illustrated by the sealing member 330 shown in FIG. 10.

It is noted that recitations herein of a component of the embodiments being “configured” in a particular way, “configured” to embody a particular property, or function in a particular manner, are structural recitations as opposed to recitations of intended use. More specifically, the references herein to the manner in which a component is “configured” denotes an existing physical condition of the component and, as such, is to be taken as a definite recitation of the structural characteristics of the component.

It is noted that one or more of the following claims utilize the term “wherein” as a transitional phrase. For the purposes of defining the embodiments of the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Although the disclosure has been illustrated and described herein with reference to explanatory embodiments and specific examples thereof, it will be readily apparent to those of ordinary skill in the art that other embodiments and examples can perform similar functions and/or achieve like results. For instance, the connection port insert may be configured as individual sleeves that are inserted into a passageway of a device, thereby allowing the selection of different configurations of connector ports for a device to tailor the device to the desired external connector. All such equivalent embodiments and examples are within the spirit and scope of the disclosure and are intended to be covered by the appended claims. It will also be apparent to those skilled in the art that various modifications and variations can be made to the concepts disclosed without departing from the spirit and scope of the same. Thus, it is intended that the present application cover the modifications and variations provided they come within the scope of the appended claims and their equivalents.

1. A fiber optic connector comprising:
a housing having a rear end and a front end with a longitudinal passageway extending from the rear end to the front end, the housing comprising a front portion, a rear portion, and at least one groove within at least one of the front portion and the rear portion; and
at least one sealing member disposed within the at least one groove, wherein the at least one sealing member is fabricated from polytetrafluoroethylene.

2. The fiber optic connector of claim 1, wherein the at least one sealing member is an O-ring.

3. The fiber optic connector of claim 1, wherein the at least one sealing member comprises a primary sealing member and a secondary sealing member, and the at least one groove comprises a primary groove and a secondary groove.

4. The fiber optic connector of claim 3, wherein the primary sealing member is an O-ring and the secondary sealing member is a tapered sealing member.

5. The fiber optic connector of claim 3, wherein each of the primary sealing member and the secondary sealing member is an O-ring.

6. The fiber optic connector of claim 1, further comprising:
a ferrule assembly comprising a ferrule comprising at least one fiber bore, a ferrule holder and a resilient member, wherein the ferrule holder comprises two alignment features disposed on a first side of ferrule holder, and a third alignment feature configured as an alignment protrusion disposed on a second side that is opposite the first side of ferrule holder; and
a ferrule retaining portion coupled to the housing and covering the ferrule assembly.

7. The fiber optic connector of claim 1, wherein the housing further comprises a transition region disposed between the front portion and the rear portion of the housing.

8. The fiber optic connector of claim 7, wherein the housing further comprises a keying portion comprising a female key.

9. The fiber optic connector of claim 8, wherein the keying portion extends into the transition region.

10. A fiber optic connector comprising:
a crimp assembly, wherein the crimp assembly includes a crimp housing and a crimp band, wherein the crimp housing comprises two half-shells being held together by the crimp band, the two half-shells having a longitudinal passageway for passing at least one optical fiber therethrough, at least one cable clamping portion, and a connector assembly clamping portion, wherein the at least one cable clamping portion secures at least one tensile element of an optical cable;
a connector assembly, the connector assembly includes a connector body and a ferrule, wherein a portion of the connector assembly is secured in the connector assembly clamping portion of the two half-shells of the crimp housing;
a shroud coupled to the crimp assembly, the shroud comprising at least one groove and a keyed passageway for inhibiting rotation between the shroud and the crimp assembly; and
at least one sealing member disposed within the at least one groove, wherein the at least one sealing member is fabricated from polytetrafluoroethylene.

11. The fiber optic connector of claim 10, wherein the at least one sealing member is an O-ring.

12. The fiber optic connector of claim 10, the connector assembly clamping portion being configured for securing more than one connector assembly.

13. The fiber optic connector of claim 10, the two half-shells having a curvilinear longitudinal passageway therethrough for routing at least one optical waveguide.

14. The fiber optic connector of claim 10, further comprising a coupling nut for removably attaching the fiber optic connector with a complementary mating receptacle.

15. The fiber optic connector of claim 10, the shroud defining a pair of openings on opposite sides of a first end, the opening extending lengthwise from a medial portion of the shroud to the first end of the shroud, wherein the ferrule is accessible within the first end of the shroud.

16. The fiber optic connector of claim 10, the shroud having two fingers for mating with a complementary receptacle, wherein the two fingers are disposed about 180 degrees apart and have different cross-sectional shapes for keying the fiber optic connector with the complementary receptacle.

17. A dust plug assembly comprising:
a dust plug body comprising a lanyard receiving feature;
a sealing sleeve attached to an end of the dust plug body, wherein:
the sealing sleeve has a passageway therethrough;
the lanyard receiving feature is disposed within the passageway; and
the dust plug body and the sealing sleeve define a primary groove;
a lanyard comprising an attachment feature, wherein:
the attachment feature is coupled to the lanyard receiving feature; and
the lanyard and the sealing sleeve define a secondary groove; and
a primary sealing member disposed in the primary groove and a secondary sealing member disposed in the secondary groove, wherein the primary sealing member and the secondary sealing member are fabricated from polytetrafluoroethylene.

18. The dust plug assembly of claim 17, wherein the primary sealing member is an O-ring and the secondary sealing member is a tapered sealing member.

19. The dust plug assembly of claim 17, wherein each of the primary sealing member and the secondary sealing member is an O-ring.

20. The dust plug assembly of claim 17, wherein:
the dust plug body further comprises an outer mating surface;
an end of the sealing sleeve contacts the outer mating surface; and
the primary groove is at the outer mating surface.
